(19) United States
(12) Patent Application Publication
(10) Pub. No.: US 2013/0242036 A1
(43) Pub. Date: Sep. 19, 2013

(54) DISPLAYING PANORAMIC VIDEO IMAGE STREAMS

(71) Applicant: Hewlett-Packard Development Company, L. P., Houston, TX (US)

(72) Inventors: Mark E. Gorzynski, Corvallis, OR (US); Michael D. Derocher, Albany, OR (US); Bradley L. Allen, Salem, OR (US)

(73) Assignee: Hewlett-Packard Development Company, L. P., Houston, TX (US)

(21) Appl. No.: 13/891,625

(22) Filed: May 10, 2013

Related U.S. Application Data
(63) Continuation of application No. 12/921,378, filed on Sep. 7, 2010.
(60) Provisional application No. 61/037,321, filed on Mar. 17, 2008.

(51) Int. Cl. H04N 5/262; H04N 7/15

(52) U.S. Cl. CPC H04N 5/2628; H04N 7/152
USPC 348/14.09; 348/36

(57) ABSTRACT

Methods and apparatus for displaying video image streams in panorama are useful in video conferencing.

### RELATED APPLICATION

This is a continuation application of U.S. patent application Ser. No. 12/921,378, titled “DISPLAYING PANORAMIC VIDEO IMAGE STREAMS” and filed Sep. 7, 2010 (pending), which is a National Stage Entry of PCT/US08/58006, titled “DISPLAYING PANORAMIC VIDEO IMAGE STREAMS” and filed Mar. 24, 2008 (published), which claims priority to U.S. Provisional Patent Application Ser. No. 61/037,321, titled “DISPLAYING PANORAMIC VIDEO IMAGE STREAMS” and filed Mar. 17, 2008 (expired), each of which is commonly assigned and incorporated herein by reference in their entirety.

### BACKGROUND

Video conferencing is an established method of simulated face-to-face collaboration between remotely located participants. A video image of a remote environment is broadcast onto a local display, allowing a local user to see and talk to one or more remotely located participants.

Social interaction during face-to-face collaboration is an important part of the way people work. There is a need to allow people to have effective social interaction in a simulated face-to-face meeting over distance. Key aspects of this are nonverbal communication between members of the group and a sense of being copresent in the same location even though some participants are at a remote location and only seen via video. Many systems have been developed that try to enable this. However, key problems have prevented them from being successful or widely used.

For the reasons stated above, and for other reasons that will become apparent to those skilled in the art upon reading and understanding the present specification, there is a need in the art for alternative video conferencing methods.

### BRIEF DESCRIPTION OF THE DRAWINGS

FIGS. 1A-1B are maps of central layouts for use with various embodiments.

FIG. 2A is a representation of a local environment in accordance with one embodiment.

FIG. 2B is a representation of a portal captured from the local environment of FIG. 1A.

FIG. 3 is a further representation of the local environment of FIG. 2A.

FIGS. 4A-4B depict portals obtained from two different fields of capture in accordance with an embodiment.

FIGS. 5A-5B depict how the relative display of multiple portals of FIGS. 4A-4B might appear when presented as a panoramic view in accordance with an embodiment.

FIG. 6 depicts an alternative display of images from local environments in accordance with another embodiment.

FIG. 7 depicts a portal displayed on a display in accordance with a further embodiment.

FIG. 8 is a flowchart of a method of video conferencing in accordance with one embodiment.

FIG. 9 is a block diagram of a video conferencing system in accordance with one embodiment.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process or mechanical changes may be made without departing from the scope of the present disclosure. The following detailed description is, therefore, not to be taken in a limiting sense, and the scope of the present disclosure is defined by the appended claims and equivalents thereof.

The various embodiments involve methods for compositing images from multiple meeting locations onto one image display. This various embodiments provide environmental rules to facilitate a composite image that promotes proper eye gaze awareness and social connectedness for all parties in the meeting. These rules enable the joining of widely distributed endpoints into effective face-to-face meetings with little customization.

By characterizing aspects of social connectedness, the various embodiments can be used to automatically blend images from different endpoints. This results in improvements in social connectedness in a widely distributed network of endpoints.

The reduction of poor, inconsistent eye contact is facilitated for all attendees by establishing consistent rules for camera positions and viewpoint arrangement using a central layout and local views. Gaze awareness is also facilitated using a central layout and local views. People onscreen in separate locations acknowledge each other's relative position by looking at them when speaking, etc.

Relative sizes of people and furniture are made geometrically consistent using rules for image capture. People across separate locations are represented on-screen at a consistent size established by the local view as opposed to arbitrary sizes established by the media stream.

An immersive sense of space is created by making items consistent such as eye level, floor level and table level. Rules are established for agreement between these items between images, and between the image and the local environment. In current systems, these items are seldom controlled and so images appear to be from different angles, many times from above.

The system of rules for central layout, local views, camera view and other environmental factors allow many types of endpoints from different manufacturers to interconnect into a consistent, multipoint meeting space that is effective for face-to-face meetings with high social connectedness.

The various embodiments facilitate creation of a panoramic image from images captured from different physical locations that, when combined, can create a single image to facilitate the impression of a single location. This is accomplished by providing rules for image capture that enable generation of a single panorama from multiple different physical locations. For some embodiments, no cropping or stitching of individual images is necessary to form a panorama. Such embodiments allow images to be simply tiled into a composited panorama with only scaling and image frame shape adjustments.

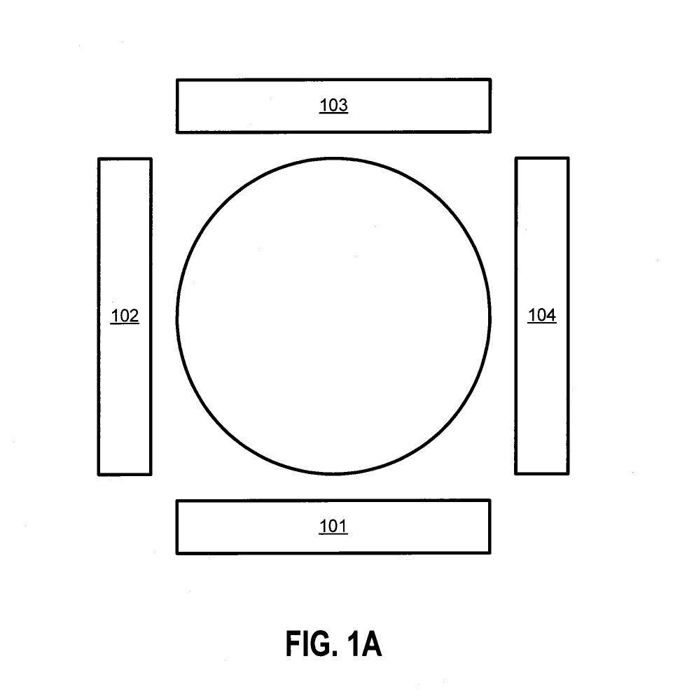

A meeting topology is defined via a central layout that shows the relative orientation of seating positions and endpoints in the layout. This layout can be an explicit map as depicted in FIGS. 1A-1B. FIG. 1A shows a circular layout of endpoints, assigning relative positions around the circle. In this central layout, endpoint 101 would have endpoint 102 on its left, endpoint 103 directly across and endpoint 104 on its right. Consistent with the central layout, endpoint 101 might then display images from endpoints 102, 103 and 104 from left to right. Note that this layout is not restricted by actual physical locations of the various endpoints, but is concerned with their relative placement within a virtual meeting space. Similarly, endpoint 102 might then display images from endpoints 103, 104 and 101 from left to right, and so on for the remaining endpoints.

FIG. 1B shows an auditorium layout of endpoints, assigning relative positions as if seated in an auditorium. In such a layout, an “instructor” endpoint 101 might display images from all remaining endpoints 102-113, while each “student” endpoint 102-113 might display only the image from endpoint 101, although additional images could also be displayed. Other central layouts simulating physical orientation of participant locations may be used and the disclosure is not limited by any particular layout.

A central layout may also be defined in terms of metadata or other abstract means. For example, a layout type “round” may be defined with attributes of sites=4, seatspersite=6 and orientation map of [A,B,C,D], indicating that four participant locations would be arranged in circular fashion in order A, B, C, D with a maximum view of six seating widths. This would permit automated ordering and scaling of images as will be described herein.

The central layout may include data structures that define environment dimensions such as distances between sites, seating widths, desired image table height, desired image foreground width and locations of media objects like white boards and data displays.

Generically, a local environment is a place where people participate in a social collaboration event or video conference, such as through audio-visual and data equipment and interfaces. A local environment can be described in terms of fields of video capture. By establishing standard or known fields of capture, consistent images can be captured at each participating location, facilitating automated construction of panoramic composite images.

For some embodiments, the field of capture for a local environment is defined by the central layout. For example, the central layout may define that each local environment has a field of capture to place six seating locations in the image. Creating video streams from standard fields of capture can be accomplished physically via Pan-Tilt-Zoom-Focus controls on cameras or digitally via digital cropping from larger images. Multiple fields can be captured from a single local space and used as separate modules. Central layouts can account for local environments with multiple fields by treating them as separate local environments, for example. One example would be an endpoint that uses three cameras, with each camera adjusted to capture two seating positions in its image, thus providing three local environments from a single participant location.

Each local environment participating in a conference would have its own view of the event. For some embodiments, each local environment will have a different view corresponding to its positioning as defined in the central layout.

The local layout is a system for establishing locations for displaying media streams that conform to these rules. The various embodiments will be described using the example of an explicit portal defined by an image or coordinates. Portals could also be defined in other ways, such as via vector graphic objects or algorithmically.

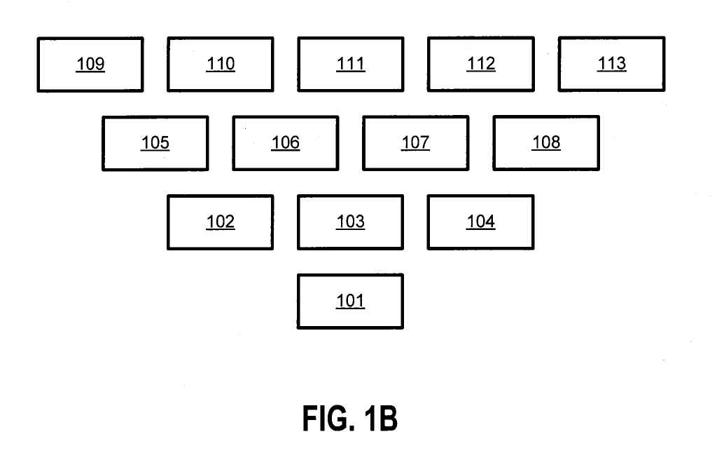

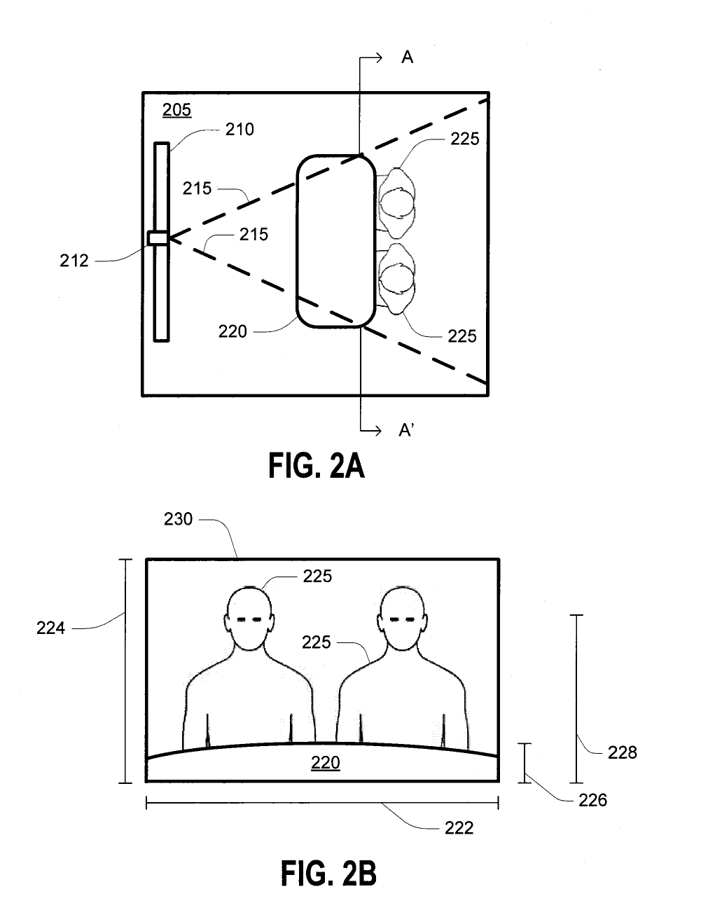

FIG. 2A is a representation of a local environment 205. Note that a remote environment as used herein is merely a local environment 205 at a different location from a particular participant. The local environment 205 includes a display 210 for displaying images from remote environments involved in a collaboration with local environment 205 and a camera 212 for capturing an image from the local environment 205 for transmission to the remote environments. For one embodiment, the camera 212 is placed above the display 210. The components for capture and display of audio-visual information from the local environment 205 may be thought of as an endpoint for use in video conferencing. The local environment 205 further includes a participant work space or table 220 and one or more participants 225. The field of capture of the camera 212 is shown as dashed lines 215. Note that the field of capture 215 may be representative of the entire view of the camera 212. However, the field of capture 215 may alternatively be representative of a cropped portion of the view of the camera 212.

FIG. 2B is a representation of a portal 230 captured from the local environment 205. The portal 230 represents a “window” on the local environment 205. The portal 230 is taken along line A-A′ where the field of capture 215 intersects the table 220. Line A-A′ is generally perpendicular to the camera 212. The portal 230 has a foreground width 222 representing the width of the table 220 depicted in the portal 230 and a foreground height 224. For one embodiment, the aspect ratio (width:height) of the portal 230 is 16:9 meaning that the foreground width 222 is 16/9 times the foreground height 224.

For one embodiment, the width of the table 220 is wider than the foreground width 222 at line A-A′ such that edges of the table do not appear in the portal 230. The portal 230 further has an image table height 226 representing a height of the table 220 within the portal 230 and an image presumed eye height 226 representing a presumed eye height of a participant 225 within the portal 230 as will be described in more detail herein.

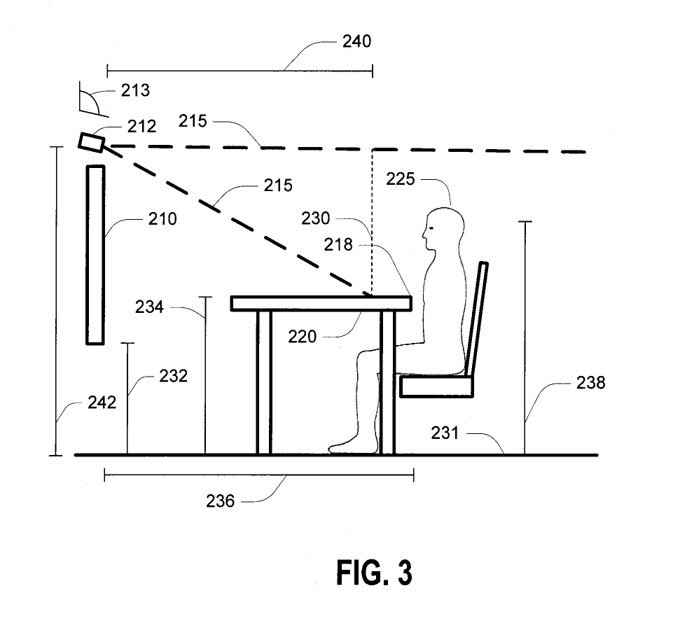

FIG. 3 is a further representation of a local environment 205 showing additional detail in environmental factors affecting the portal 230 and the viewable image of remote locations. Again, the field of capture of the camera 212 is shown by dashed lines 215. The display 210 is located a distance 232 above a floor 231 and a distance 236 from a back edge 218 of the table 220. The camera 212 may be positioned similar to the display 210, i.e., it may also be located a distance 236 from the back edge 218 of the table 220. The camera 212 may also be positioned at an angle 213 in order to obtain a portal 230 having a desired aspect ratio at a location perpendicular to the intersection of the field of capture 215 with the table 220.

The table 220 has a height 234 above the floor 231. A presumed eye height of a participant 225 is given as height 238 from the floor 231. The presumed eye height 238 does not necessarily represent an actual eye height of a participant, but merely the level at which the eyes of an average participant might be expected to occur when seated at the table 220. For example, using ergonomic data, one might expect a 50% seated stature eye height of 47″. The choice of a presumed eye height 238 is not critical. For one embodiment, however, the presumed eye height 238 is consistent across each local environment participating in a video conference, facilitating consistent scaling and placement of portals for display at a local environment.

The portal 230 is defined by such parameters as the field of capture 215 of the camera 212, the height 234 of the table 220, the angle 213 of the camera 212 and the distance 240 from the camera 212 to the intersection of the field of capture 215 with the table 220. The presumed eye height 238 of a local environment 205 defines the image presumed eye height 228 within the portal 230. In other words, the eyes of a hypothetical participant having a seated eye height occurring at presumed eye height 238 of the local environment would result in an eye height within the portal 230 defining the image presumed eye height 228.

For one embodiment, the distance 236 from the camera 212 to the back edge 218 of table 220 and the angle 213 are consistent across each local environment 205 involved in a collaboration. In such an embodiment, as the field of capture 215 is increased to increase the foreground width 222 of the portal 230, the distance 240 from the camera 212 to the intersection of the field of capture 215 with the table 220 is lessened, thus resulting in an increase in the image table height 226 and a reduction of the image presumed eye height 228 of the portal 230.

For further embodiments, by maintaining consistency of height 234 of table 220 and distance 236 of the back edge 218 of the table 220 from the camera 212, as well as the height 242 of the camera 212, consistent portals 230 may be produced across each local environment 205 using different zoom factors. This facilitates alignment of table heights and presumed eye heights within each portal produced using the same field of capture, allowing the images to be placed adjacent one another to provide an impression of a single work space. Alternatively, or in addition, fields of capture 215 for each local environment 205 may be selected from a group of standard fields of capture. The standard fields of capture may be defined to view a set number of seating widths. For example, a first field of capture may be defined to view two seating positions, a second field of capture may be defined to view four seating positions, a third field of capture may be defined to view six seating positions, and so one.

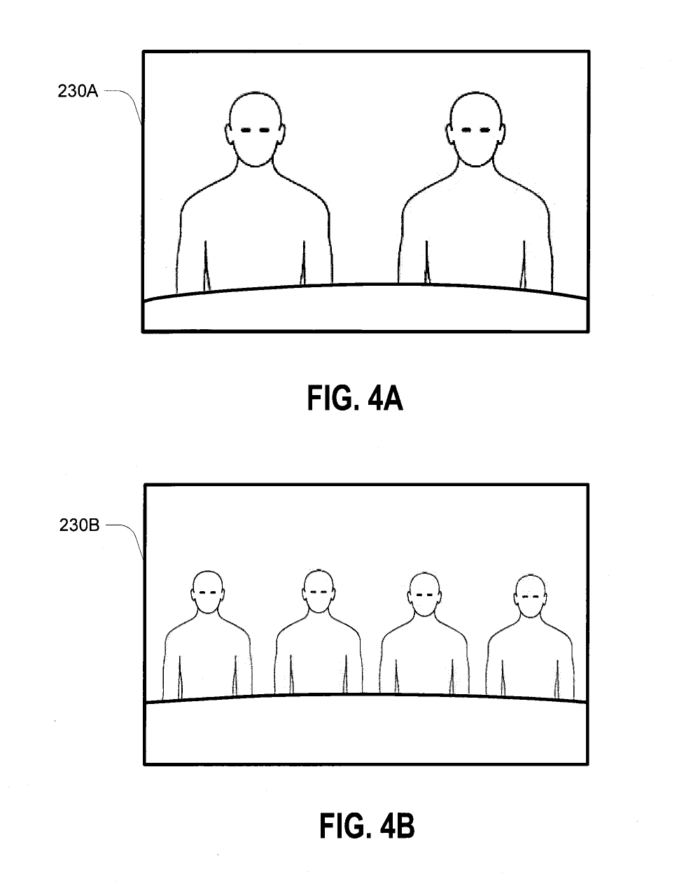

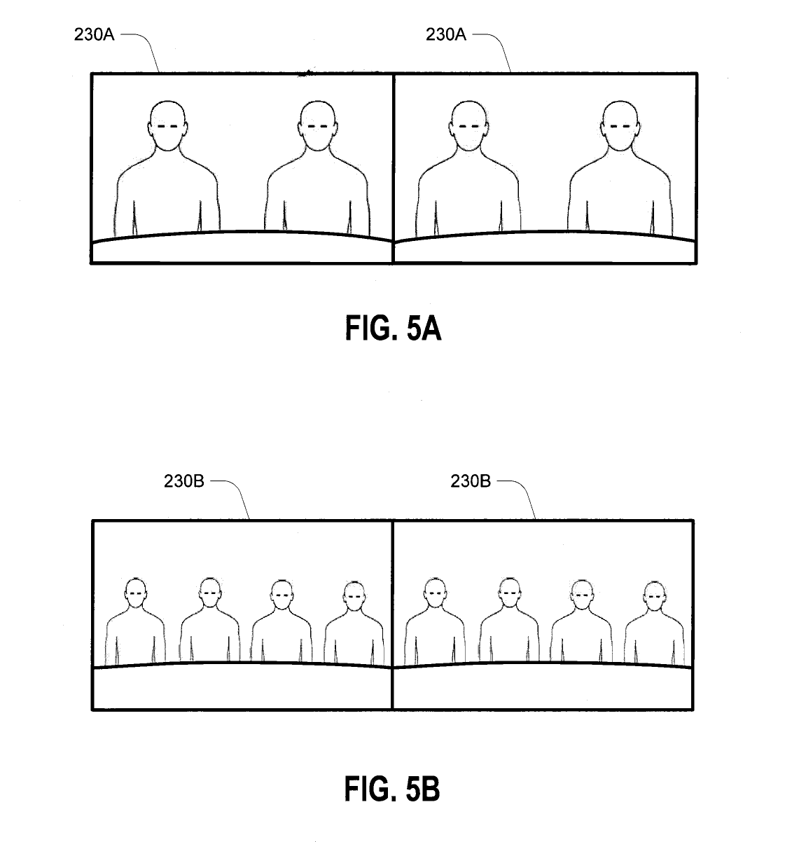

FIGS. 4A-4B depict portals 230 obtained from two different fields of capture. Portals 230A and 230B of FIGS. 4A and 4B, respectively, have dimensional characteristics, i.e., foreground width, foreground height, image table height and image presumed eye height, as described with reference to FIG. 2B. Portal 230A has a smaller field of capture than portal 230B in that its foreground width is sufficient to view two seating locations while the field of capture for portal 230B is sufficient to view four seating locations. To obtain geometric consistency of the participants, it would thus be necessary to display portal 230A at a smaller magnification than portal 230B. FIGS. 5A-5B show how the relative display of multiple portals 230A and 230B might appear when images from multiple remote locations are presented together. By defining the same fields of capture for each image to be presented together, image table height and image presumed eye height can be consistent across the resulting panorama. The compositing of the multiple portals 230 into a single panoramic image defines a continuous frame of reference of the remote locations participating in a collaboration. This continuous frame of reference preserves the scale of the participants for each remote location. For one embodiment, it maintains a continuity of structural elements. For example, the tables appear to form a single structure as the defined field of capture defines the edges of the table to appear at the same height within each portal.

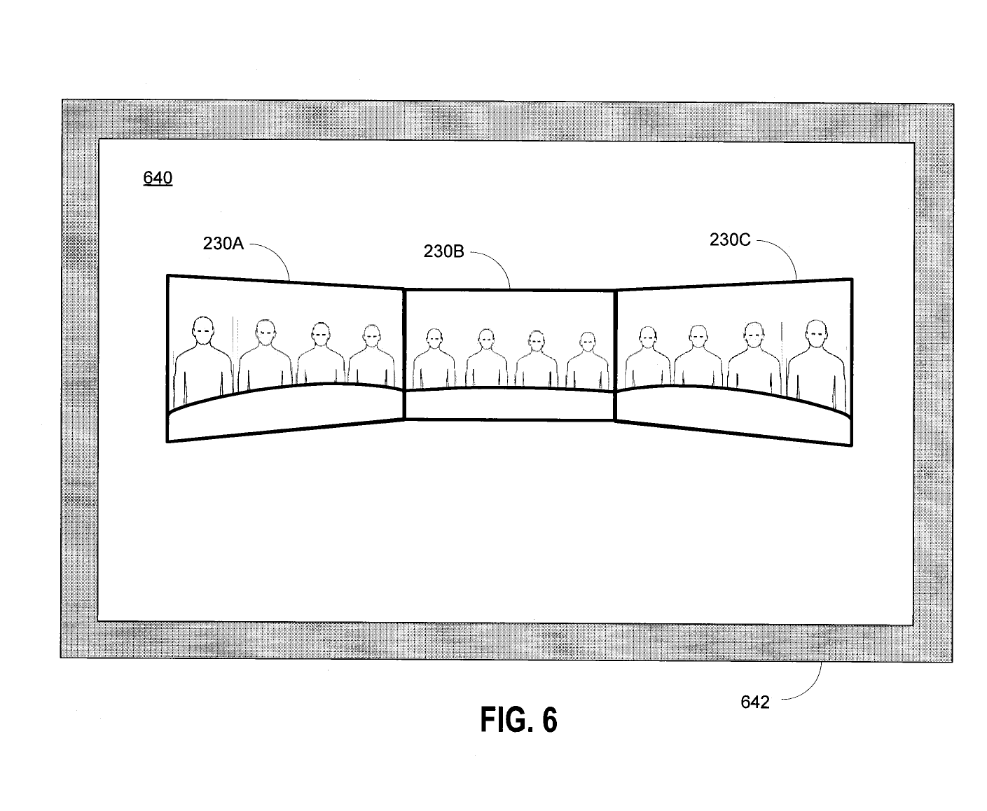

When parameters are chosen to define the fields of capture such that the scaled portals have similar pixel dimensions (to a casual observer) between their presumed eye height (228 in FIG. 2B) and table height (226 in FIG. 2B), the portals can be placed adjacent one another and can appear to have their participants seated at the same work space and scaled to the same magnification as both the presumed eye heights and table heights within the portals will be in alignment. Further, the perspective of the displayed portals 230 may be altered to promote an illusion of a surrounding environment. FIG. 6 depicts three portals 230A-230C showing an alternative display of images from three local environments, each having fields of capture to view four seating locations. The outer portals 230A and 230C are displayed in perspective to appear as if the participants appearing in those portals are closer than participants appearing in portal 230B. Referring to FIG. 1A, the placement of portals 230A-230C of FIG. 5 may represent the display as seen at endpoint 101, with portal 230A representing the video stream from endpoint 102, portal 230B representing the video stream from endpoint 103 and portal 230C representing the video stream from endpoint 104, thereby maintaining the topography defined by the central layout. The perspective views of endpoints 102 and 104 help promote the impression that all participants are seated around one table.

As shown in FIG. 6, the displayed panoramic image of the portals 230A-230C may not take up the whole display surface 640 of a video display. For one embodiment, the display surface 640 may display a gradient of color to reduce reflections. This gradient may approach a color of a surface 642 surrounding the display surface 640. For one embodiment, the color gradient is varying shades of the color of the surface 642. For example, where the color of surface 642 is black, the display surface 640 outside the panoramic image may be varying shades of gray to black. For a further embodiment, the color gradient is darker closer to the surface 642. To continue the foregoing example, the display surface 640 outside the panoramic image may extend from gray to black going from portals 230A-230C to the surface 642.

For some embodiments, the portals 230 are displayed such that their image presumed eye height is aligned with the presumed eye height of the local environment displaying the images. This can further facilitate an impression that the participants at the remote environments are seated in the same space as the participants of the local environment when their presumed eye heights are aligned.

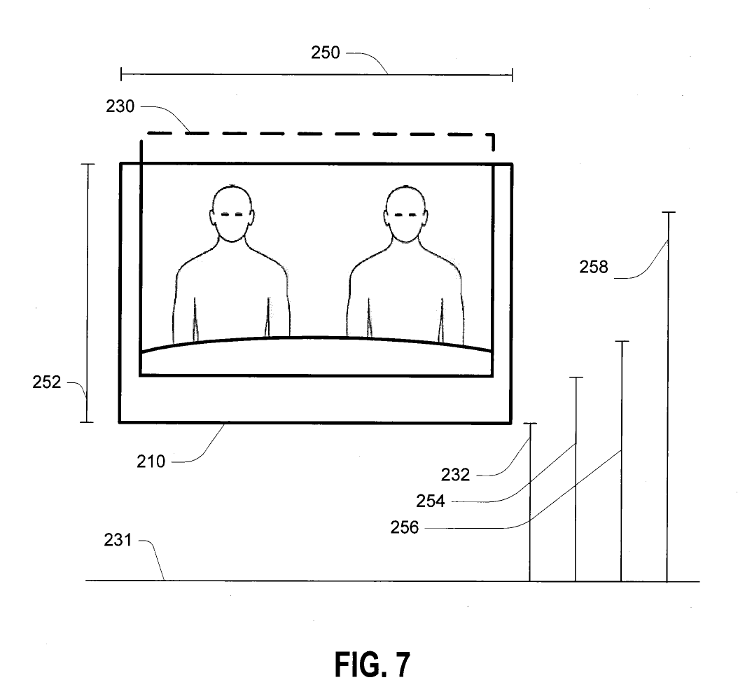

FIG. 7 depicts a portal 230 displayed on a display 210. Display 210 has a viewing area defined by a viewing width 250 and a viewing height 252. The display is located a distance 232 from the floor 231. If displaying the portal 230 in the viewing area of display 210 results in a displayed presumed eye height 258 from floor 231 that is less than the presumed eye height 238 of the local environment, the portal may be shifted up in the viewing area to increase the displayed presumed eye height 258. Note that portions of the portal 230 may extend outside the viewing area of display 210, and thus would not be displayed. However, if this portion outside the viewing area does not contain any relevant information, e.g., each participant is viewable within the viewing area, the loss of this image information may be inconsequential. Thus, the bottom of the portal 230 could be shifted up from the bottom of the display 210 to a distance 254 from the floor 231 in order to bring the presumed eye height within the displayed portal 230 to a level 258 equal to the presumed eye height 238 of a local environment. Alternatively, the bottom of the portal 230 could be shifted up from the bottom of the display 210 to a distance 254 from the floor 231 in order to bring the displayed table height within the displayed portal 230 to a level 256 aligned with the table height 234 of a local environment.

For some embodiments, it may not be possible to display the participants of the portal 230 at their full or normal size. For example, the viewing area of the display 210 may not permit full-size display of the participants due to size limitations of the display 210 and the number of participants that are desired to be displayed. In such situations, a compromise may be in order as bringing the displayed presumed eye height in alignment with the presumed eye height of a local environment may bring the displayed table height 256 to a different level than the table height 234 of a local environment, and vice versa. For some embodiments, wherein the displayed image is less than full scale, the portal 230 could be shifted up from the bottom of the display a distance 254 that would bring the displayed presumed eye height 258 to a level less than the presumed eye height 238 of the local environment, thus bringing the displayed table height 256 to a level greater than the table height 234 of the local environment.

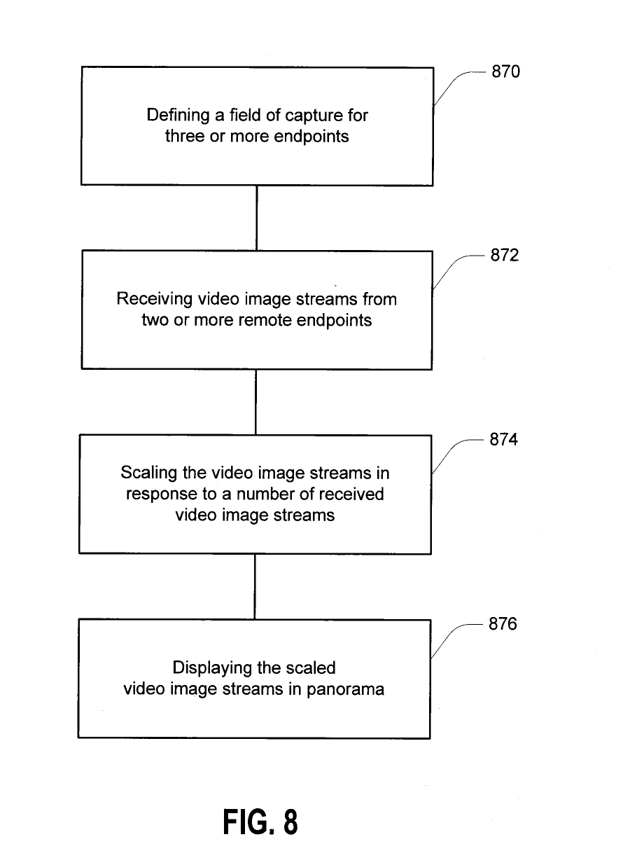

FIG. 8 is a flowchart of a method of video conferencing in accordance with one embodiment. At 870, a field of capture is defined for three or more endpoints. For example, the field of capture may be defined by the central layout. The field of capture is the same for each endpoint involved in the video conference, even though they may have differing numbers of participants. For one embodiment, a management system may direct each remote endpoint to use a specific field of capture. The remote endpoints would then adjust their cameras, either manually or automatically, to obtain their specified field of capture. For such embodiments, the fields of capture would be determined from the management system. When fields of capture are defined by a management system, received fields of capture may, out of convenience, be presumed to be the same as the defined field of capture even though it may vary from its expected dimensional characteristics.

At 872, video image streams are received from two or more remote locations. The video image streams represent the portals of the local environments of the remote endpoints.

At 874, the video image streams are scaled in response to a number of received image streams to produce a composite image that fits within the display area of a local endpoint. If non-participant video image streams are received, such as white boards or other data displays, these video image streams may be similarly scaled, or they may be treated without regard to the scaling of the remaining video image streams.

At 876, the scaled video image streams are displayed in panorama for viewing at a local environment. By maintaining consistency of camera and table placement, and using a single field of capture, the scaled video image streams may be displayed adjacent one another to promote the appearance that participants of all of the remote endpoints are seated at a single table. As noted above, the scaled video image streams may be positioned within a viewable area of a display to obtain eye heights similar to those of the local environment in which they are displayed. One or more of the scaled video image streams may further be displayed in perspective. For further embodiments, the video image streams are displayed in an order representative of a central layout chosen for the video conference of the various endpoints. As noted previously, non-participant video image streams may be displayed along with video image streams of participant seating.

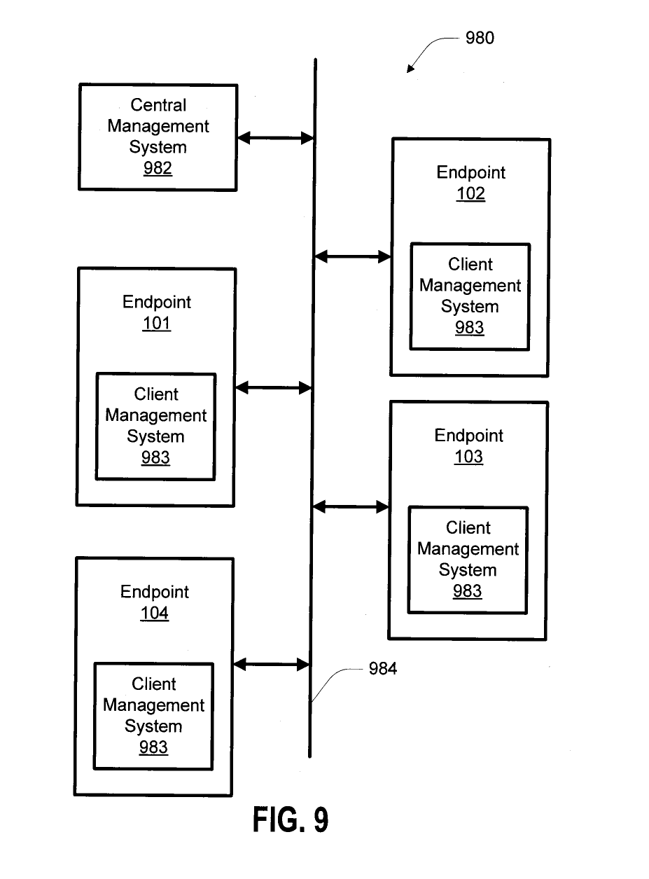

FIG. 9 is a block diagram of a video conferencing system 980 in accordance with one embodiment. The video conferencing system 980 includes one or more endpoints 101-104 for participating in a video conference. The endpoints 101-104 are in communication with a network 984, such as a telephonic network, a local area network (LAN), a wide area network (WAN) or the Internet. Communication may be wired and/or wireless for each of the endpoints 101-104. A management system is configured to perform methods described herein. The management system includes a central management system 982 and client management systems 983. Each of the endpoints 101-104 includes its own client management system 983. The central management system 982 defines which endpoints are participating in a video conference. This may be accomplished via a central schedule or by processing requests from a local endpoint. The central management system 982 defines a central layout for the event and local layouts for each local endpoint 101-104 participating in the event. The central layout may define standard fields of capture, such as 2 or 4 person views and location of additional media streams, etc. The local layouts represent order and position of information needed for each endpoint to correctly position streams into the local panorama. The local layout provides stream connection information linking positions in a local layout to image stream generators in remote endpoints participating in the event. The client management systems 983 use the local layout to construct the local panorama as described, for example, with reference to FIG. 6.

The client management system 983 may be part of an endpoint, such as a computer associated with each endpoint, or it may be a separate component, such as a server computer. The central management system 982 may be part of an endpoint or separate from all endpoints.

In practice, the central management system 982 may contact each of the endpoints involved in a given video conference. The central management system 982 may determine their individual capabilities, such as camera control, display size and other environmental factors. For embodiments using global control of portal characteristics, the central management system 982 may then define a single standard field of capture for use among the endpoints 101-104 and communicate these via local meeting layouts passed to the client management systems 983. The client management systems 983 use information from the local meeting layout to cause cameras of the endpoints 101-104 to be properly aligned in response to the standard specified fields of capture. Local, specific fields of capture then are insured to result in video image streams that correspond to the standardized stream defined by the local and central layout.

Upon defining the characteristics controlling the capture and display of video information, the central management system 982 may create a local meeting layout for each local endpoint. Client management systems 983 use these local layouts to create a local panorama receiving a portal from each remaining endpoint for viewing on its local display as part of the constructed panorama. The remote portals are displayed in panorama as a continuous frame of reference to the video conference for each endpoint. The topography of the central layout may be maintained at each endpoint to promote gaze awareness and eye contact among the participants. Other attributes of the frame of reference may be maintained across the panorama including alignment of tables, image scale, presumed eye height and background color and content.

What is claimed is:

1. A method, comprising:
receiving two or more video image streams having a defined field of capture;
scaling the image steams in response to a number of received video image streams; and
displaying the scaled image streams in panorama.

2. The method of claim 1, further comprising defining the field of capture of the video image streams.

3. The method of claim 2, wherein defining fields of capture of the video image streams comprises defining one or more parameters selected from the group consisting of a camera height, an angle of the camera, a distance from the camera to a back edge of a participant work space, a distance from the camera to a floor, a height of the participant work space, a foreground width of a portal located perpendicular from the camera and from the participant work space, an aspect ratio of the portal, a presumed eye height within the portal, a height of the participant work space within the portal and a maximum scaling of the portal.

4. The method of claim 3, wherein defining fields of capture of the video image streams comprises defining the one or more parameters to obtain scaled video streams having consistent pixel dimensions between presumed eye heights of the scaled video image streams and participant work space heights of the scaled video image streams.

5. The method of claim 3, wherein defining a foreground width of a portal located perpendicular from the camera and from the participant work space comprises defining a number of seating widths to be viewed in the portal.

6. The method of claim 5, wherein scaling the image steams in response to a number of received video image streams comprises reducing a pixel size for each video image stream such that a panorama of the received video image streams is less than a pixel size of a video display for displaying the video image streams.

7. The method of claim 1, wherein displaying the scaled video image streams in panorama comprises displaying at least one scaled video image stream positioned within a display to align at least one of presumed eye heights and table heights of that scaled video image stream and a local environment containing the display.

8. The method of claim 1, wherein displaying the scaled video image streams in panorama comprises displaying at least one scaled video image stream positioned within a display to align a presumed eye height and a table height of that scaled video image stream between a presumed eye height and a table height of a local environment containing the display.

9. The method of claim 1, wherein displaying the scaled video image streams in panorama comprises displaying one or more of the scaled video image streams in perspective.

10. The method of claim 1, wherein displaying the scaled video image streams in panorama comprises displaying the scaled video image streams in an order defined by a central layout representative of a presumed physical orientation of locations generating the video image streams.

11. The method of claim 1, further comprising displaying one or more additional video image streams.

12. The method of claim 1, further comprising displaying the video image streams in panorama against a background containing a color gradient.

13. The method of claim 12, wherein the color gradient extends from the panoramic display of the scaled video image streams to a surface surrounding a display on which the scaled video image streams are displayed.

14. The method of claim 13, wherein the color gradient is varying shades of a color of the surrounding surface, and wherein the color gradient is darker closer to the surrounding surface.

15. A client management system of an endpoint for use in a video conference system having two or more endpoints, comprising:
first logic configured to receive a layout;
second logic configured to receive a video image stream from one or more remote endpoints defined in the layout, wherein each of the received video image streams corresponds to a field of capture defined in the layout; and
third logic configured to generate a panorama at the given endpoint of each of the received video image streams having an order, position and scale defined in the layout.

16. The client management system of claim 15, wherein the layout defines an order of the video image streams to be in an order representative of presumed relative orientations of the remaining endpoints to the given endpoint.

17. The client management system of claim 15, wherein the client management system is configured to scale the video image streams to display the scaled video image streams in panorama within a viewing area of a display of the given endpoint.

18. The client management system of claim 17, wherein the client management system is further configured to display the scaled video image streams with a background containing a color gradient.

19. The client management system of claim 15, wherein the client management system is further configured to scale the video image streams to display one or more of the scaled video image streams in perspective within a viewing area of a display of the given endpoint.

20. The client management system of claim 15, wherein the client management system is in communication with a central management system for receiving the layout, and wherein the central management system is part of the given endpoint.

21. A method of using a client management system of a local endpoint to process video image streams from two or more remote endpoints in a video conferencing system, comprising:
receiving a layout for use by the local endpoint;
receiving a video image stream from two or more remote endpoints defined in the layout and corresponding to a field of capture defined in the layout; and
generating a local panorama of the video image streams for each of the remote endpoints each having an order, position and scale defined in the layout.

22. The method of claim 21, wherein the layout defines an order of the video image streams to be in an order representative of presumed relative orientations of the remote endpoints to the local endpoint.

23. The method of claim 21, further comprising scaling the video image streams to display the scaled video image streams in panorama within a viewing area of a display of the local endpoint.

24. The method of claim 23, further comprising displaying the scaled video image steams with a background containing a color gradient.

25. The method of claim 21, further comprising scaling the video image streams to display one or more of the scaled video image streams in perspective within a viewing area of a display of the local endpoint.
